(19) United States
(12) Patent Application Publication
(10) Pub. No.: US 2026/0146499 A1
(43) Pub. Date: May 28, 2026

(54) ELECTROMECHANICAL ACTUATOR FOR A SCREENING DEVICE, AND SCREENING DEVICE COMPRISING SUCH AN ELECTROMECHANICAL ACTUATOR

(71) Applicant: SOMFY ACTIVITES SA, CLUSES (FR)

(72) Inventor: Fernando VELOSO, CLUSES (FR)

(21) Appl. No.: 19/483,530

(22) PCT Filed: May 14, 2024
(86) PCT No.: PCT/EP2024/063175

§ 371 Date: Nov. 11, 2025

(30) Foreign Application Priority Data
May 15, 2023 (FR) FR2304801

(51) Int. Cl. E06B 9/322

(52) U.S. Cl. CPC E06B 9/322; E06B 2009/3222

(57) ABSTRACT

An electromechanical actuator (11) comprises a casing (17), an electric motor (16), a gearbox (19a, 19b), a coupling element (20a, 20b) and a torque transmission device (10a, 10b). The gearbox (19a, 19b) is coupled to the coupling element (20a, 20b) via the device (10a, 10b). The device (10a, 10b) comprises a drive shaft (38), a first pin (39) and a second pin (40). The drive shaft (38) comprises a first aperture and a second aperture. The first pin (39) is housed inside the first aperture. The second pin (40) is housed inside the second aperture. A first end of the drive shaft (38) is arranged inside a first housing (43) of the gearbox (19a, 19b). Furthermore, a second end of the drive shaft (38) is arranged inside a second housing (44) of the coupling element (20a, 20b). The actuator (11) is configured to transmit, from the electric motor (16), a torque to the coupling element (20a, 20b), through the device (10a, 10b), when an axis of rotation (X10a, X10b) of the device (10a, 10b) and an axis of rotation (X20a, X20b) of the coupling element (20a, 20b) are out of alignment.

The present invention relates to an electromechanical actuator of a screening device, in other words an electromechanical actuator for a screening device.

The present invention also relates to a screening device comprising a screen moved by such an electromechanical actuator.

In general, the present invention relates to the field of screening devices comprising a motorized driving device for moving a screen, between at least one first position and at least one second position and, eventually, between at least one third position and at least one fourth position.

And, more particularly, the present invention relates to the field of screening devices comprising at least a screen, a first movable bar, a second movable bar and a motorized driving device. In an assembled configuration of the screening device, the first movable bar is arranged between an upper part of a window or door and the second movable bar. The second movable bar is positioned between the first movable bar and a lower part of the window or door. The screen is arranged between the first and second movable bars. The screen is configured to be moved by the motorized driving device. The motorized driving device moves, on the one hand, the first movable bar connected to the screen, between at least one first position and at least one second position, and, on the other hand, the second movable bar connected to the screen, between at least one third position and at least one fourth position.

A motorized driving device comprises an electromechanical actuator of a movable occultation or solar protection element, such as a blind or any other equivalent equipment, hereinafter referred to as a screen.

US 2008/0102965 A1 is already known, which describes an electromechanical actuator comprising a casing, an electric motor, a gearbox, a coupling element and a torque transmission device. The electric motor, the gearbox and the torque transmission device are housed inside the casing. The gearbox is coupled to the coupling element via the torque transmission device.

The torque transmission device comprises a transmission element and a guide element. The transmission element comprises, on a first side, a receiving orifice and, on a second side opposite the first side, a projecting element. The guide element comprises, on a first side, a first groove and, on a second side opposite the first side, a second groove. The first groove is angled at right angle to the second groove. The coupling element comprises, on a first side, a projecting element and, on a second side opposite the first side, an orifice, this orifice being configured to be coupled with a shaft.

In the assembled configuration of the electromechanical actuator, the gearbox is coupled to the transmission element by inserting an output shaft of the gearbox into the receiving orifice of the transmission element. The transmission element is coupled to the guide element by inserting the projecting element of the transmission element into the first groove of the guide element. Furthermore, the coupling element is coupled to the guide element by inserting the projecting element of the coupling element into the second groove of the guide element.

Thus, the electromechanical actuator comprises a first coupling between the transmission element and the guide element and a second coupling between the guide element and the coupling element together forming an assembly known as an “Oldham cross”.

Such an assembly between the transmission element, the guide element and the coupling element allows misalignment of the axes of rotation of each of these elements to be corrected, in particular when the output shaft of the gearbox is rotated by the electrical activation of the electric motor.

However, the disadvantage of assembling this electromechanical actuator in this way is that only a slight misalignment of the axes of rotation of the transmission element, the guide element and the coupling element is corrected and only a small amount of torque is transmitted from the electric motor to the coupling element via the torque transmission device.

EP 2 182 163 A1 is also known, which describes an electromechanical actuator according to the preamble of claim 1.

The purpose of the present invention is to overcome the aforementioned drawbacks and to provide an electromechanical actuator of a screening device, as well as a screening device comprising such an electromechanical actuator, making it possible to transmit, from an electric motor, a significant torque to a coupling element, via a torque transmission device, when an axis of rotation of the torque transmission device and an axis of rotation of the coupling element are out of alignment.

To this end, the present invention relates, according to a first aspect, to an electromechanical actuator for a screening device,
the electromechanical actuator comprising at least:
   a casing,
   an electric motor,
   a gearbox,
   a coupling element, the coupling element comprising a first axis of rotation, and
   a torque transmission device, the torque transmission device comprising a second axis of rotation,
the electric motor, the gearbox and the torque transmission device being housed inside the casing,
the gearbox being coupled to the coupling element via the torque transmission device.

According to the invention, the torque transmission device comprises at least:
a drive shaft,
a first pin, and
a second pin.

The drive shaft comprises at least:
a first end and a second end, the second end being opposite the first end,
a first aperture, the first aperture being arranged at the first end, the first pin being housed within the first aperture, and
a second aperture, the second aperture being arranged at the second end, the second pin being housed within the second aperture.

The gearbox comprises at least one first housing, the first end of the drive shaft being arranged within the first housing of the gearbox.

The coupling element comprises at least one second housing, the second end of the drive shaft being arranged within the second housing of the coupling element.

Furthermore, the electromechanical actuator is configured to transmit, in other words transmits, torque from the electric motor to the coupling element, through the torque transmission device, when the second axis of rotation of the torque transmission device and the first axis of rotation of the coupling element are out of alignment.

Thus, such a construction design of the electromechanical actuator makes it possible to transmit, from the electric motor, a torque, in particular a large amount, to the coupling element, via the torque transmission device, when the second axis of rotation of the torque transmission device and the first axis of rotation of the coupling element are out of alignment, in particular by a large amount.

According to an advantageous feature of the invention, each of the first and second ends of the drive shaft is spherical in shape. Furthermore, the first housing of the gearbox and the second housing of the coupling element have a shape of revolution, respectively around an axis of rotation.

According to another advantageous feature of the invention, the gearbox further comprises at least one interface element. Furthermore, the first housing of the gearbox is arranged inside the interface element.

According to another advantageous feature of the invention, the torque transmission device further comprises a first transmission element and a second transmission element. The first transmission element is fixed to the first pin. The second transmission element is fixed to the second pin. The gearbox comprises a first groove, the first groove emerging inside the first housing of the gearbox. The coupling element comprises a second groove, the second groove emerging inside the second housing of the coupling element. The first transmission element is housed inside the first groove of the gearbox. Furthermore, the second transmission element is housed inside the second groove of the coupling element.

In a variant, the gearbox comprises two first grooves, each of the first grooves emerging inside the first housing of the gearbox. The coupling element comprises two second grooves, each of the second grooves emerging inside the second housing of the coupling element. The first pin comprises a first end and a second end, the second end being opposite the first end. The second pin comprises a first end and a second end, the second end being opposite the first end. Each of the first and second ends of the first pin is housed inside one of the first grooves in the gearbox. Furthermore, each of the first and second ends of the second pin is housed inside one of the second grooves of the coupling element.

In a variant, the gearbox comprises two first orifices, each of the first orifices emerging inside the first housing of the gearbox. The coupling element comprises two second orifices, each of the second orifices emerging inside the second housing of the coupling element. The first pin comprises a first end and a second end, the second end being opposite the first end. The second pin comprises a first end and a second end, the second end being opposite the first end. Each of the first and second ends of the first pin is fixed inside one of the first orifices of the gearbox. Furthermore, each of the first and second ends of the second pin is fixed inside one of the second orifices of the coupling element.

The present invention relates, in a second aspect, to a screening device,
the screening device comprising at least:
   a screen, the screen comprising a first end and a second end, the second end being opposite the first end,
   a first movable bar, the first end of the screen being connected to the first movable bar, and
   a motorized driving device, the motorized driving device being configured to move the screen,
the motorized driving device comprising at least:
   an electromechanical actuator according to the invention and as mentioned above, the electromechanical actuator being configured to move the first movable bar.

This screening device has similar features and advantages to those described above in relation to the electromechanical actuator according to the invention.

According to one advantageous feature of the invention, the screening device further comprises:
a first cord or a first chain,
a second cord or a second chain,
a first drive arrangement, the first drive arrangement being configured to cooperate with the first cord or the first chain, and
a second drive arrangement, the second drive arrangement being configured to cooperate with the second cord or the second chain.

Furthermore, the electromechanical actuator is configured to move the first movable bar by means of the first and second cords or chains.

According to another advantageous feature of the invention, the screening device further comprises a second movable bar, the second end of the screen being connected to the second movable bar. Furthermore, the electromechanical actuator is configured to move the second movable bar.

According to another advantageous feature of the invention, the screening device further comprises:
a third cord or a third chain,
a fourth cord or a fourth chain,
a third drive arrangement, the third drive arrangement being configured to cooperate with the third cord or the third chain, and
a fourth drive arrangement, the fourth drive arrangement being configured to cooperate with the fourth cord or the fourth chain.

Furthermore, the electromechanical actuator is configured to move the second movable bar by means of the third and fourth cords or chains.

Further features and advantages of the invention will become apparent from the following description, made with reference to the attached drawings, which are given as non-limiting examples and wherein:

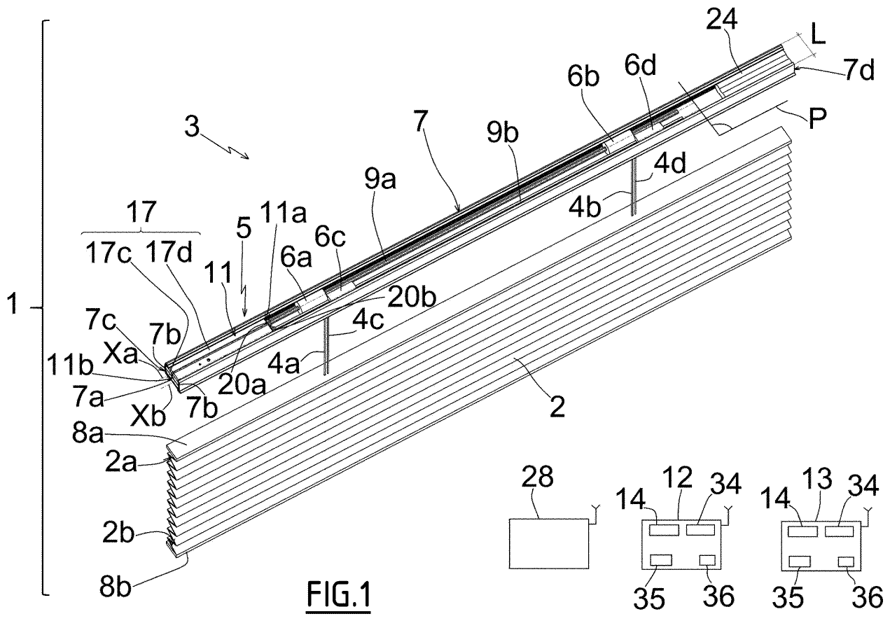

FIG. 1 is a schematic perspective view of an installation comprising a screening device according to a first embodiment of the invention;

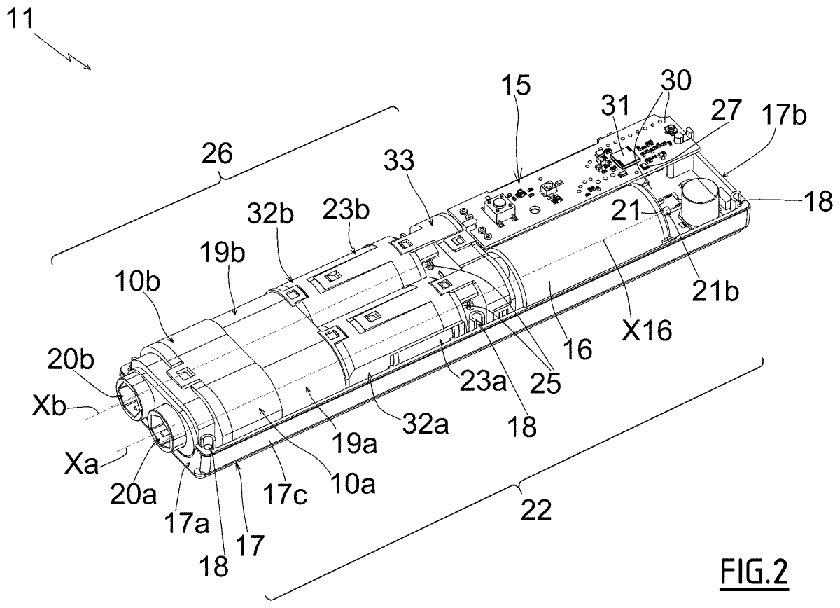

FIG. 2 is a schematic perspective view of an electromechanical actuator of a motorized driving device of the screening device illustrated in FIG. 1, with a cover removed;

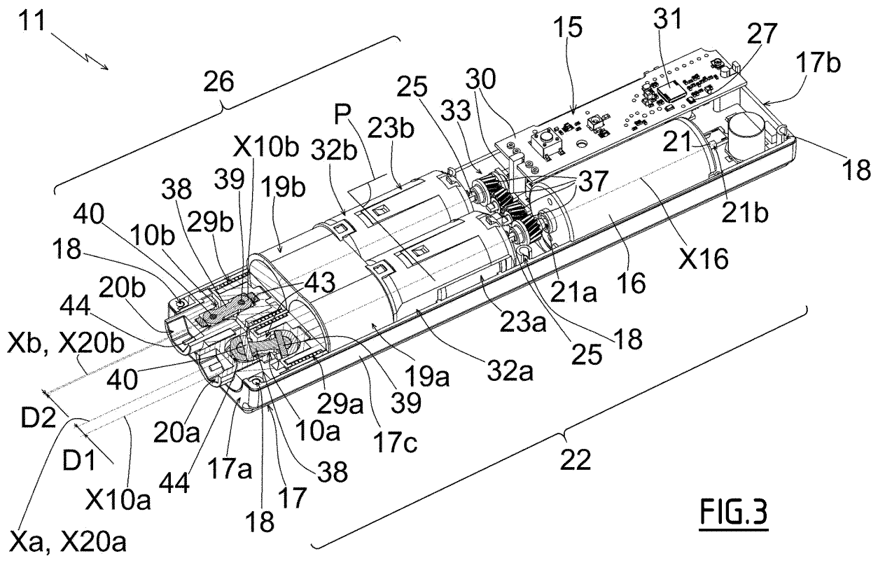

FIG. 3 is a schematic view similar to FIG. 2 in which part of the electromechanical actuator is in cross-section and part of a housing of a coupling device has been removed;

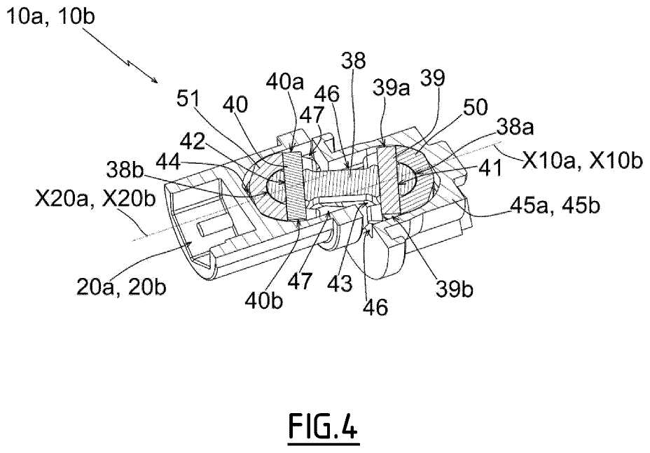

FIG. 4 is a schematic cross-sectional perspective view of a torque transmission device of the electromechanical actuator illustrated in FIGS. 1 to 3 according to the first embodiment;

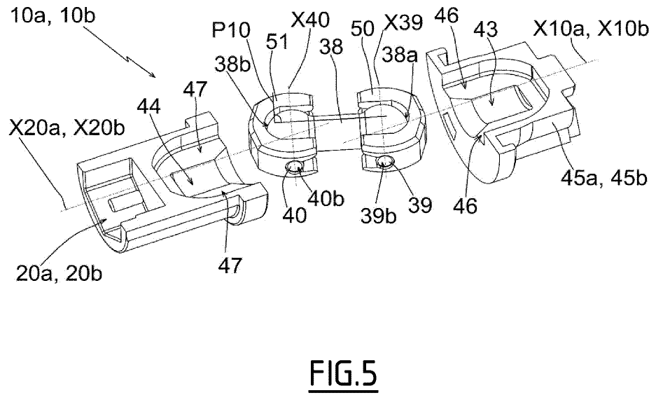

FIG. 5 is a schematic exploded view of the torque transmission device illustrated in FIG. 4;

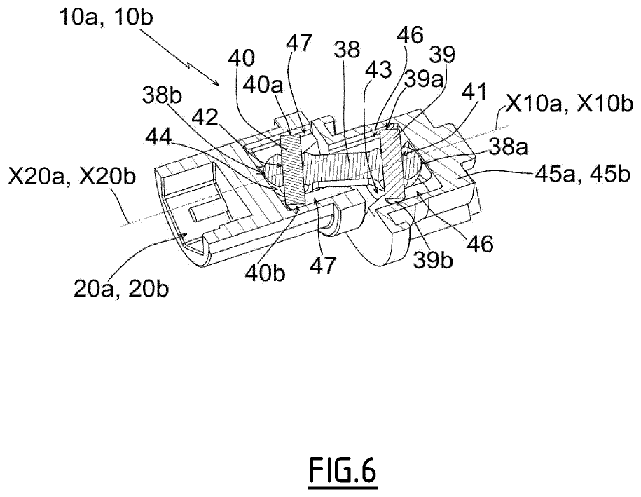

FIG. 6 is a schematic view similar to FIG. 4 illustrating a torque transmission device in a second embodiment;

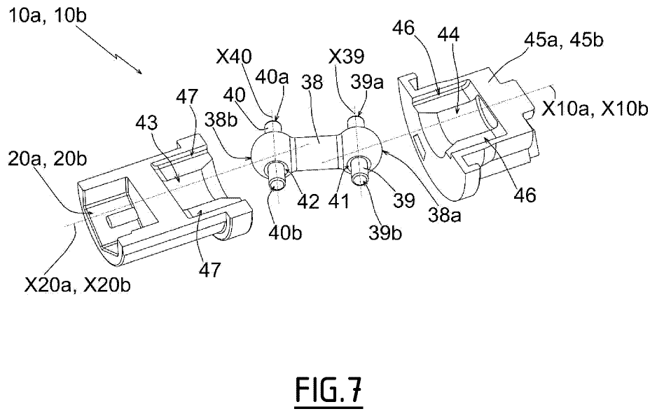

FIG. 7 is a schematic exploded view of the torque transmission device illustrated in FIG. 6;

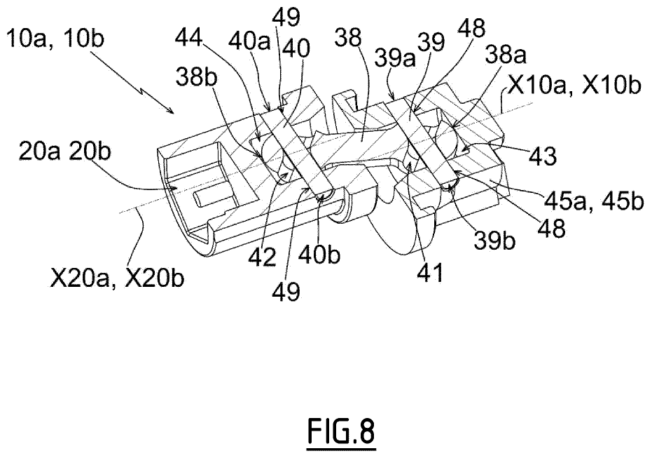

FIG. 8 is a schematic view similar to FIGS. 4 and 6 illustrating a torque transmission device in a third embodiment; and

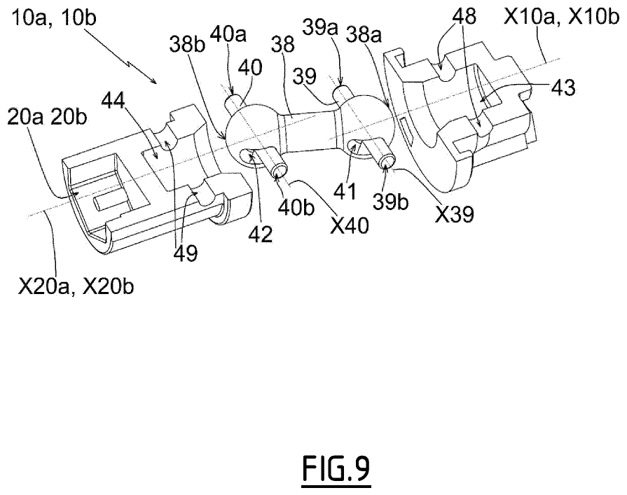

FIG. 9 is a schematic exploded view of the torque transmission device illustrated in FIG. 8.

Firstly, with reference to FIG. 1, an installation 1 comprising a closure, occultation or solar protection device 3 according to a first embodiment of the invention is described. This installation 1, installed in a building, not shown, comprises an aperture, not shown, in which a window or a door, not shown, is arranged. This installation 1 is equipped with a screen 2 belonging to the closure, occultation or solar protection device 3, in particular a motorized blind. The screen 2 is configured to at least partially conceal the aperture arranged in a wall of the building.

The closure, occultation or solar protection device 3 is hereinafter referred to as the “screening device”. The screening device 3 comprises the screen 2.

Here, the screen 2 can be formed, for example, from a pleated or honeycombed fabric or from slats that can be orientated.

The screen 2 comprises a first end 2a, in particular an upper end, and a second end 2b, in particular a lower end, the second end 2b being opposite the first end 2a.

With reference to FIG. 1, a blind according to the first embodiment of the invention is described.

The screening device 3 comprises a first movable bar 8a, in particular an upper movable bar. The first end 2a of the screen 2 is connected to the first movable bar 8a.

Here, the screening device 3 further comprises a second movable bar 8b, in particular a lower movable bar. The second end 2b of the screen 2 is connected to the second movable bar 8b.

Thus, the screen 2 is arranged, in other words is configured to be deployed, between the first and second movable bars 8a, 8b. Depending on the relative position of the first and second movable bars 8a, 8b, the screen 2 is deployed to a greater or lesser extent.

Here, the second movable bar 8b is identical to the first movable bar 8a.

In a variant, not shown, the second movable bar 8b is different from the first movable bar 8a.

The screening device 3 comprises a motorized driving device 5. The motorized driving device 5 is configured to move, in other words moves, the screen 2.

Advantageously, the screening device 3 further comprises a housing 7. The motorized driving device 5 is mounted, in other words is housed, in the housing 7, in particular in an assembled configuration of the screening device 3. The housing 7 is mounted, in other words is configured to be mounted, at the top of or above the aperture, in particular in an assembled configuration of the screening device 3 in the installation 1. The housing 7 is generally referred to as a rail and, more particularly, as a top rail.

Advantageously, the housing 7 has a U-shaped cross-section. In other words, the housing 7 comprises a bottom wall 7a and two side walls 7b. Each of the side walls 7b is connected to the bottom wall 7a of the housing 7. Furthermore, each of the side walls 7b is perpendicular to the bottom wall 7a of the housing 7.

The housing 7 comprises a first end 7c and a second end 7d. The second end 7d is opposite the first end 7c.

The motorized driving device 5 comprises at least one electromechanical actuator 11.

Here, the electromechanical actuator 11 is mounted, in other words is housed, inside the housing 7, in particular in the assembled configuration of the screening device 3.

The electromechanical actuator 11 comprises a first end 11a and a second end 11b, the second end 11b being opposite the first end 11a.

Here, in the installation 1, a high end-of-travel position corresponds to a position in which the first movable bar 8a can no longer move upwards, in particular by approaching the housing 7. The high end-of-travel position can either be predetermined, or correspond to the first movable bar 8a bearing against the housing 7. Furthermore, a low end-of-travel position corresponds to a position in which the second movable bar 8b can no longer move downwards, in particular away from the housing 7 or from the first movable bar 8a. The low end-of-travel position can either be predetermined, or correspond to the second movable bar 8b bearing against a threshold of the aperture, or correspond to the complete unrolling of the screen 2.

Advantageously, the motorized driving device 5 comprises at least one drive shaft 9a, 9b. Furthermore, the electromechanical actuator 11 is configured to rotate, in other words rotates, the drive shaft 9a, 9b, so as to move the, one or each of the first and second movable bars 8a, 8b.

Here, the motorized driving device 5 comprises a first drive shaft 9a and a second drive shaft 9b. Furthermore, the electromechanical actuator 11 is configured to rotate, in other words rotates, the first drive shaft 9a, so as to move the first movable bar 8a, and is configured to rotate, in other words rotates, the second drive shaft 9b, so as to move the second movable bar 8b.

Advantageously, the first and second drive shafts 9a, 9b are parallel to each other.

Here, the first and second drive shafts 9a, 9b are located on a same side of the electromechanical actuator 11, as illustrated in FIG. 1.

Advantageously, the screening device 3 comprises a first cord 4a, a second cord 4b, a first drive arrangement 6a and a second drive arrangement 6b. The first drive arrangement 6a is configured to cooperate, in other words cooperates, with the first cord 4a. The second drive arrangement 6b is configured to cooperate, in other words cooperates, with the second cord 4b. Furthermore, the electromechanical actuator 11 is configured to move, in other words moves, the first movable bar 8a via the first and second cords 4a, 4b.

Advantageously, the first drive arrangement 6a is configured to wind and unwind, in other words winds and unwinds, the first cord 4a. Furthermore, the second drive arrangement 6b is configured to wind and unwind, in other words winds and unwinds, the second cord 4b.

Thus, when the first and second cords 4a, 4b are wound by means of the first and second drive arrangements 6a, 6b, the first movable bar 8a is raised towards the housing 7. Furthermore, when the first and second cords 4a, 4b are unwound by means of the first and second drive arrangements 6a, 6b, the first movable bar 8a is lowered away from the housing 7.

Advantageously, each of the first and second cords 4a, 4b is attached to the first movable bar 8a.

Here, the screening device 3 further comprises a third cord 4c, a fourth cord 4d, a third drive arrangement 6c and a fourth drive arrangement 6d. The third drive arrangement 6c is configured to cooperate, in other words cooperates, with the third cord 4c. Furthermore, the fourth drive arrangement 6d is configured to cooperate, in other words cooperates, with the fourth cord 4d. Furthermore, the electromechanical actuator 11 is configured to move, in other words moves, the second movable bar 8b via the third and fourth cords 4c, 4d.

Advantageously, the third drive arrangement 6c is configured to wind and unwind, in other words winds and unwinds, the third cord 4c. Furthermore, the fourth drive arrangement 6d is configured to wind and unwind, in other words winds and unwinds, the fourth cord 4d.

Thus, when the third and fourth cords 4c, 4d are wound by means of the third and fourth drive arrangements 6c, 6d, the second movable bar 8b is raised towards the housing 7. Furthermore, when the third and fourth cords 4c, 4d are unwound by means of the third and fourth drive arrangements 6c, 6d, the second movable bar 8b is lowered away from the housing 7.

### Advantageously, each of the third and fourth cords 4c, 4d is attached to the second movable bar 8b.

Thus, the first, second, third and fourth cords 4a, 4b, 4c, 4d connect the first and second drive shafts 9a, 9b to the first and second movable bars 8a, 8b.

In this way, the first, second, third and fourth cords 4a, 4b, 4c, 4d support the screen 2.

Here, the third and fourth drive arrangements 6c, 6d are identical to the first and second drive arrangements 6a, 6b respectively.

The first, second, third and fourth drive arrangements 6a, 6b, 6c, 6d can also be referred to as first, second, third and fourth winders.

Advantageously, the first, second, third and fourth drive arrangements 6a, 6b, 6c, 6d each comprise at least one pulley configured to wind or unwind one of the first, second, third and fourth cords 4a, 4b, 4c, 4d.

Advantageously, the first and second drive arrangements 6a, 6b, respectively the third and fourth drive arrangements 6c, 6d, are mounted, in other words are housed, inside the housing 7, in particular in the assembled configuration of the screening device 3.

The motorized driving device 5 is thus configured to move, in other words moves, in particular in a vertical direction, the first and second movable bars 8a, 8b of the screening device 3, via the first, second, third and fourth cords 4a, 4b, 4c, 4d, by means of the electromechanical actuator 11.

Advantageously, the first and second movable bars 8a, 8b are parallel to each other, in particular in the assembled configuration of the screening device 3. Furthermore, the first and second drive shafts 9a, 9b are parallel to the first and second movable bars 8a, 8b, in particular in the assembled configuration of the screening device 3.

In a variant, not shown, the first drive shaft 9a is coupled to the second movable bar 8b and the second drive shaft 9b is coupled to the first movable bar 8a, instead of the first drive shaft 9a being coupled to the first movable bar 8a and the second drive shaft 9b being coupled to the second movable bar 8b, as explained above.

Advantageously, the motorized driving device 5 and, more particularly, the electromechanical actuator 11 is controlled by a command unit. The command unit can be, for example, a local command unit 12 or a central command unit 13.

Advantageously, the local command unit 12 can be connected to the central command unit 13, via a wired or wireless connection.

Advantageously, the central command unit 13 can control the local command unit 12, and other similar local command units distributed throughout the building.

The motorized driving device 5 is, preferably, configured to execute the commands for moving, especially for deploying or retracting, the screen 2, which can be emitted, especially, by the local command unit 12 or the central command unit 13.

The installation 1 comprises the local command unit 12, the central command unit 13, or both the local command unit 12 and the central command unit 13.

The motorized driving device 5, including the electromechanical actuator 11, belonging to the installation 1 and, more particularly, to the screening device 3 illustrated in FIG. 1, is now described, in more detail and in reference to FIGS. 2 to 3, according to the first embodiment of the invention.

The electromechanical actuator 11 comprises an electric motor 16. The electric motor 16 is shown by its outline in FIGS. 2 and 3, without details of its internal components.

Here, the electromechanical actuator 11 comprises a single electric motor 16.

Advantageously, the electric motor 16 of the electromechanical actuator 11 comprises a rotor 21 and a stator, not shown, positioned coaxially around an axis of rotation X16.

Advantageously, the electric motor 16 of the electromechanical actuator 11 can be of the electronically switched brushless type, also known as “BLDC” (BrushLess Direct Current) or “permanent magnet synchronous”, or DC type.

Advantageously, the rotor 21 of the electric motor 16 comprises a first end 21a, in other words a first output, and a second end 21b, in other words a second output. The second end 21b is opposite the first end 21a.

Means for controlling the electromechanical actuator 11, allowing the movement of the screen 2, comprise at least one control unit 15, in particular an electronic control unit, shown in FIGS. 2 and 3.

Here, the electromechanical actuator 11 further comprises the control unit 15.

In a variant, not shown, the control unit 15 is arranged outside the electromechanical actuator 11 and, for example, is located inside the housing 7. In this case, the control unit 15 is electrically connected to at least the electric motor 16 via an electrical link.

The control unit 15 is able to turn on the electric motor 16 and, in particular, to enable the supply of electrical energy to the electric motor 16.

Thus, the control unit 15 controls, especially, the electric motor 16, so as to unfold or fold the screen 2 and, more particularly, so as to raise or lower the first movable bar 8a and, therefore, the upper part of the screen 2, and so as to raise or lower the second movable bar 8b and, therefore, the lower part of the screen 2.

Advantageously, the control unit 15 comprises hardware and/or software means.

By way of a non-limiting example, the hardware means of the control unit 15 comprise at least one microcontroller 31.

Advantageously, the control unit 15 further comprises a first communication module 27, in particular for receiving command orders, the command orders being emitted by an order transmitter, such as the local command unit 12 or the central command unit 13, these orders being intended to control the electromechanical actuator 11.

Advantageously, the first communication module 27 is wireless. In particular, the first communication module 27 is configured to receive radio command orders.

In a variant or additionally, the first communication module 27 can allow the reception of command orders transmitted by wired means.

Advantageously, the control unit 15, the local command unit 12 and/or the central command unit 13 can be in communication with a weather station, not shown, located inside the building or remote outside the building, including, especially, one or more sensors that can be configured to determine, for example, temperature, brightness, or wind speed, in the case where the weather station is placed outside the building.

Advantageously, the control unit 15, the local command unit 12, and/or the central command unit 13 can also be in communication with a server 28, so as to control the motorized driving device 5 and, more particularly, the electromechanical actuator 11, according to data made available remotely via a communication network, in particular an Internet network that can be connected to the server 28.

The control unit 15 can be controlled from the local command unit 12 and/or the central command unit 13. The local command unit 12 or the central command unit 13 is provided with a control keyboard. The control keyboard comprises one or more selection elements 14 and, eventually, one or more display elements 34.

By way of non-limiting examples, the selection elements can comprise push buttons and/or touch-sensitive keys. The display elements can comprise light-emitting diodes and/or a display, for example an LCD (Liquid Crystal Display) display or TFT (Thin Film Transistor) display. The selection and display elements can also be realised by means of a touch screen.

Advantageously, the local command unit 12 or the central command unit 13 further comprises at least one second communication module 36.

Thus, the second communication module 36 is configured to emit, in other words emits, command orders, in particular by wireless means, for example radio, or by wired means.

Furthermore, the second communication module 36 can also be configured to receive, in other words receives, command orders, in particular via the same means.

Advantageously, the second communication module 36 of the local command unit 12 or the central command unit 13 is configured to communicate, in other words communicates, with the first communication module 27 of the control unit 15.

Thus, the second communication module 36 of the local command unit 12 or the central command unit 13 exchanges command orders with the first communication module 27 of the control unit 15, either monodirectionally or bidirectionally.

Advantageously, the local command unit 12 is a command point, which can be fixed or mobile. A fixed command point can be a control box to be fixed on a facade of a wall of a building or on a face of a frame of a window or a door. A mobile command point can be a remote control, a smartphone or a tablet.

Advantageously, the local command unit 12 or the central command unit 13 further comprises a controller 35.

The motorized driving device 5, in particular the control unit 15, is, preferably, configured to carry out command orders for controlling the movement, especially the retraction and deployment, of the screen 2. These command orders can be emitted, especially, by the local command unit 12 or by the central command unit 13.

The motorized driving device 5 can be controlled by the user, for example by receiving a command order corresponding to pressing the or one of the selection elements 14 of the local command unit 12 or the central command unit 13.

The motorized driving device 5 can also be controlled automatically, for example by receiving a command order corresponding to at least one signal from at least one sensor, not shown, and/or a signal from a clock, not shown, of the control unit 15, in particular the microcontroller. In a variant, the sensor and/or the clock can be integrated in the local command unit 12 or in the central command unit 13.

The electromechanical actuator 11 further comprises a casing 17, in particular of parallelepiped shape.

Advantageously, the electric motor 16 is mounted, in other words is housed, inside the casing 17, in particular in an assembled configuration of the electromechanical actuator 11.

The casing 17 comprises a first end 17a and a second end 17b, the second end 17b being opposite the first end 17a.

The first end 17a of the casing 17 faces the first end 11a of the electromechanical actuator 11, while the second end 17b of the casing 17 faces the second end 11b of the electromechanical actuator 11. FIGS. 1 and 2 are viewed from opposite angles.

Here, the casing 17 is made of plastic.

The material of the casing is not limiting and can be different. In particular, this can be a metallic material.

Advantageously, the casing 17 comprises a base 17c and a cover 17d, which is shown only in FIG. 1. Furthermore, the cover 17d is fastened, in other words is configured to be fastened, to the base 17c by means of fastening elements, not shown, in particular in the assembled configuration of the electromechanical actuator 11.

Here, the fastening elements are fastening screws, of which there are six in particular. The fastening screws pass through through-orifices, not shown, in the cover 17d and are screwed into screw orifices 18 arranged in the base 17c. The number of through-orifices and the number of screw orifices are equal to the number of fastening screws. Only three screw orifices 18 are visible in FIG. 2 and only four screw orifices 18 are visible in FIG. 3.

The type and the number of fastening elements are non-limiting and can be different. They can, for example, be snap-fit fastening elements or a combination of different fastening elements, especially screw and snap-fit fastening elements.

Here, the control unit 15 comprises a first and a second electronic boards 30.

Advantageously, each of the first and second electronic boards 30 is mounted, in other words is housed, inside the casing 17, in particular in the assembled configuration of the electromechanical actuator 11.

Advantageously, the first electronic board 30 is configured to control the electric motor 16. Furthermore, the second electronic board is configured, especially, to access functions for setting parameters and/or configuring the electromechanical actuator 11, by means of selection devices and, eventually, display devices, not shown. Furthermore, the second electronic board 30 is configured to enable recharging of a battery 24.

In a variant, not shown, the control unit 15 comprises a single electronic board 30. Advantageously, the electronic board 30 is mounted, in other words is housed, inside the casing 17, in particular in the assembled configuration of the electromechanical actuator 11.

Advantageously, the electromechanical actuator 11 is supplied with electrical energy by an electrical energy supply source.

Advantageously, the electrical energy supply source is the battery 24. The battery 24 is shown by its outline in FIG. 1, without details of its internal components.

Thus, the battery 24 is configured to supply electrical energy, in other words supplies electrical energy, to the electromechanical actuator 11 and, more particularly, the electric motor 16 and the control unit 15.

Advantageously, the battery 24 is mounted, in other words is housed, inside the housing 7, in particular in the assembled configuration of the screening device 3.

Here, the motorized driving device 5 further comprises the battery 24.

In a variant, not shown, the battery 24 is mounted, in other words is housed, in the casing 17, in particular in the assembled configuration of the electromechanical actuator 11, which itself is mounted inside the housing 7, in particular in the assembled configuration of the screening device 3.

In another variant, not shown, the battery 24 is mounted outside the housing 7, in particular in the assembled configuration of the screening device 3. In this case, the battery 24 can be fastened against one of the side walls 7b of the housing 7, in particular by means of at least one fastening element, such as, for example, at least one retaining bracket, while being arranged outside the housing 7.

Advantageously, the battery 24 comprises one or more electrical energy storage elements, not shown. The electrical energy storage elements can be, especially, accumulators, if the battery 24 is of the rechargeable type, or cells.

Advantageously, the control unit 15 comprises charging elements configured to charge the battery 24 from electrical energy supplied by an external electrical energy supply source, not shown. The charging elements comprise at least one electrical connector, not shown, if the battery 24 is of the rechargeable type. The external electrical energy supply source is configured to be electrically connected to the electrical connector, via an electrical energy supply cable, not shown.

Advantageously, the external electrical energy supply source is a charger, that can be connected to a wall socket, so as to recharge the battery 24, from an electrical energy supply network, in particular from the mains.

In a variant, the external electrical energy supply source can be an auxiliary battery or a photovoltaic panel.

In a variant, not shown, the electrical energy supply source is an electrical energy supply network, especially from the mains or “PoE” (Power over Ethernet). In this case, the motorized driving device 5 further comprises a transformer, to complement or replace the battery 24.

Here, the control unit 15 comprises a first and a second electronic boards 30.

Advantageously, each of the first and second electronic boards 30 is mounted, in other words is housed, inside the casing 17, in particular in the assembled configuration of the electromechanical actuator 11.

Advantageously, the first electronic board 30 is configured to control the electric motor 16. Furthermore, the second electronic board is configured, especially, to access functions for setting parameters and/or configuring the electromechanical actuator 11, by means of selection devices and, eventually, display devices, not shown. Furthermore, the second electronic board 30 is configured to enable the battery 24 to be recharged.

Advantageously, the motorized driving device 5 further comprises a power supply cable, not shown.

Thus, the power supply cable enables the electromechanical actuator 11 to be supplied with electrical energy from the electrical energy supply source.

Advantageously, the power supply cable comprises at least one electrical connector, not shown, especially one at each of its ends or a single connector at one of its ends.

Here, the power supply cable is a string with electrical connectors, especially of the RJ 45 type (Registered Jack), in the case where the electromechanical actuator 11 is supplied with electrical energy from the battery 24 or, eventually, from a “PoE” electrical energy supply network.

In a variant, not shown, the power supply cable is a cord, in the case where the electromechanical actuator 11 is supplied with electrical energy from a mains electrical energy supply network, which can have, for example, a supply voltage of 110 Volts or 230 Volts.

Advantageously, the electromechanical actuator 11 is located at the first end 7c of the housing 7. The battery 24 and/or the transformer is located at the second end 7d of the housing 7. Furthermore, the electromechanical actuator 11 is electrically connected to the battery 24 or to the transformer via the power supply cable.

The electromechanical actuator 11 further comprises at least one coupling element 20a, 20b, in other words an output shaft.

Here, the electromechanical actuator 11 comprises a first coupling element 20a, in other words a first output shaft, and a second coupling element 20b, in other words a second output shaft.

Thus, the electromechanical actuator 11 is an electromechanical actuator with two outputs.

Advantageously, the first and second coupling elements 20a, 20b are arranged at the first end 11a of the electromechanical actuator 11.

Thus, the two outputs of the electromechanical actuator 11 are arranged on the same side of the electromechanical actuator 11, in particular the casing 17.

Furthermore, the first and second drive shafts 9a, 9b are arranged on the same side of the electromechanical actuator 11 as the first and second coupling elements 20a, 20b. Advantageously, the first coupling element 20a is rotatable, around a first axis of rotation Xa, inside the housing 7. The second coupling element 20b is rotatable, around a second axis of rotation Xb, inside the housing 7. The first drive shaft 9a rotationally fixed to the first coupling element 20a, around the first axis of rotation Xa. Furthermore, the second drive shaft 9b is rotationally fixed to the second coupling element 20b, around the second axis of rotation Xb.

Thus, the electric motor 16 is configured to rotate, in other words rotates, on the one hand, the first coupling element 20a, so as to rotate the first drive shaft 9a, and, on the other hand, the second coupling element 20b, so as to rotate the second drive shaft 9b.

Here, the first and second coupling elements 20a, 20b are arranged on the same side of the electric motor 16.

Here, the first and second coupling elements 20a, 20b are identical.

Advantageously, the first and second axes of rotation Xa, Xb are arranged in the same horizontal plane P. In this case, the plane P is parallel to the bottom wall 7a of the housing 7.

In a variant, not shown, the first and second axes of rotation Xa, Xb are arranged in the same vertical plane. In this case, the plane is perpendicular to the bottom wall 7a of the housing 7.

In another variant, not shown, the first and second axes of rotation Xa, Xb are staggered in an oblique plane. In this case, the plane is inclined relative to the bottom wall 7a of the housing 7 by a value comprised between 0° and 90° or between 90° and 180°.

Regardless of the position of the first and second axes of rotation Xa, Xb relative to the housing 7, the first and second drive shafts 9a, 9b are arranged in the same arrangement as the first and second coupling elements 20a, 20b relative to the housing 7.

The electromechanical actuator 11 further comprises at least one gearbox 19a, 19b.

Here, the electromechanical actuator 11 comprises a first gearbox 19a and a second gearbox 19b. Each of the first and second gearboxes 19a, 19b is shown by its outline in FIGS. 2 and 3, in particular by means of a housing common to the first and second gearboxes 19a, 19b, without details of its internal components.

Each of the first and second gearboxes 19a, 19b comprises at least one reduction stage. The reduction stage can be, for example, an epicyclic gear train.

The type and the number of reduction stages of each of the first and second gearboxes are not limiting. The number of reduction stages can be, for example, three, but also two or four.

Advantageously, the first gearbox 19a is configured to transmit, in other words transmits, a movement generated by the electric motor 16 to the first coupling element 20a, and then to the first drive shaft 9a. Furthermore, the second gearbox 19b is configured to transmit a movement generated by the electric motor 16 to the second coupling element 20b, and then to the second drive shaft 9b.

Each of the first and second gearboxes 19a, 19b comprises an input shaft and an output shaft, not shown.

Advantageously, the first and second gearboxes 19a, 19b are mounted, in other words are housed, inside the casing 17, in particular in the assembled configuration of the electromechanical actuator 11.

Here, the first and second gearboxes 19a, 19b are identical.

Advantageously, the electromechanical actuator 11 further comprises at least one clutch 23a, 23b.

Here, the electromechanical actuator 11 comprises a first clutch 23a and a second clutch 23b. Each of the first and second clutches 23a, 23b is shown by its outline in FIGS. 2 and 3, without details of its internal components.

Advantageously, the first clutch 23a is configured to be engaged or disengaged, in other words is engaged or disengaged, so as to secure or release, at least in rotation, the first coupling element 20a and, therefore, the first drive shaft 9a with respect to the electric motor 16, in particular at the first end 21a of the rotor 21 of the electric motor 16. Furthermore, the second clutch 23b is configured to be engaged or disengaged, in other words is engaged or disengaged, so as to secure or release, at least in rotation, the second coupling element 20b and, therefore, the second drive shaft 9b with respect to the electric motor 16, in particular at the first end 21a of the rotor 21 of the electric motor 16.

Thus, each of the first and second clutches 23a, 23b is configured to be toggled either into an engaged position or into a disengaged position.

Advantageously, the engagement and disengagement of the first and second clutches 23a, 23b is controlled by the control unit 15.

Advantageously, each of the first and second clutches 23a, 23b comprises an input shaft 25 and an output shaft, not shown. “Engage” means to use an engagement, within each of the first and second clutches 23a, 23b, to mechanically couple its input shaft 25 and its output shaft and transmit a rotational movement between this input shaft 25 and this output shaft.

“Disengage” means to use a disengagement, within each of the first and second clutches 23a, 23b, to uncouple its input shaft 25 and its output shaft and not to transmit any movement between this input shaft 25 and this output shaft.

Advantageously, when the electric motor 16 is electrically activated and only one of the first and second clutches 23a, 23b is engaged, only one of the first and second coupling elements 20a, 20b and, therefore, only one of the first and second drive shafts 9a, 9b is rotated by the electric motor 16. Furthermore, when the electric motor 16 is electrically activated and the first and second clutches 23a, 23b are engaged, the first and second coupling elements 20a, 20b and, therefore, the first and second drive shafts 9a, 9b are rotated by the electric motor 16.

Thus, the first clutch 23a provides a first transmission, in other words a first mechanical link, between the electric motor 16 and the first coupling element 20a and, therefore, the first drive shaft 9a. Furthermore, the second clutch 23b provides a second transmission, in other words a second mechanical link, between the electric motor 16 and the second coupling element 20b and, therefore, the second drive shaft 9b.

Advantageously, each of the first and second clutches 23a, 23b is monostable or bistable.

Here, each of the first and second clutches 23a, 23b is a friction clutch, in other words by adhesion.

The type of each of the first and second clutches is not restrictive and can be different. It can, for example, be a dog clutch.

Advantageously, the first and second clutches 23a, 23b are mounted, in other words are housed, inside the casing 17, in particular in the assembled configuration of the electromechanical actuator 11.

Here, the first and second clutches 23a, 23b are identical.

Advantageously, the electromechanical actuator 11 further comprises at least one brake 29a, 29b.

Here, the electromechanical actuator 11 comprises a first brake 29a and a second brake 29b, shown in FIG. 3.

By way of non-limiting examples, each of the first and second brakes can be a spring brake, a cam brake, a magnetic brake or an electromagnetic brake.

Advantageously, the first brake 29a is configured to brake and/or to rotationally block, in other words brakes and/or rotationally blocks, the first coupling element 20a and, therefore, the first drive shaft 9a, so as to regulate the speed of movement of the first movable bar 8a, during a movement of the screen 2, and to hold the first movable bar 8a in position, when the electromechanical actuator 11 is electrically deactivated and/or when the first clutch 23a is disengaged. Furthermore, the second brake 29b is configured to brake and/or to rotationally block, in other words brakes and/or rotationally blocks, the second coupling element 20b and, therefore, the second drive shaft 9b, so as respectively to regulate the speed of movement of the second movable bar 8b, during movement of the screen 2, and to hold the second movable bar 8b in position, when the electromechanical actuator 11 is electrically deactivated and/or when the second clutch 23b is disengaged.

Here, the first brake 29a is configured to be arranged, in other words is arranged, in particular in the assembled configuration of the electromechanical actuator 11, between the first gearbox 19a and the first coupling element 20a, in other words at the output of the first gearbox 19a. Furthermore, the second brake 29b is configured to be arranged, in other words is arranged, in particular in the assembled configuration of the electromechanical actuator 11, between the second gearbox 19b and the second coupling element 20b, in other words at the output of the second gearbox 19b.

In a variant, not shown, each of the first and second brakes 29a, 29b is respectively configured to be arranged, in other words is respectively arranged, in particular in the assembled configuration of the electromechanical actuator 11:
between two reduction stages of the first gearbox 19a, or between two reduction stages of the second gearbox 19b, or
between the first clutch 23a and the first gearbox 19a, in other words at the output of the first clutch 23a, or between the second clutch 23b and the second gearbox 19b, in other words at the output of the second clutch 23b.

Advantageously, the first and second brakes 29a, 29b are mounted, in other words are housed, inside the casing 17, in particular in the assembled configuration of the electromechanical actuator 11.

Here, the first and second brakes 29a, 29b are identical.

Advantageously, the first gearbox 19a is connected, in other words is configured to be connected, to the rotor 21 of the electric motor 16, via the first clutch 23a, in particular in the assembled configuration of the electromechanical actuator 11. Furthermore, the second gearbox 19b is connected, in other words is configured to be connected, to the rotor 21 of the electric motor 16, via the second clutch 23b, in particular in the assembled configuration of the electromechanical actuator 11.

Advantageously, the electromechanical actuator 11 further comprises an end-of-travel and/or obstacle detection device, which can be mechanical or electronic.

Advantageously, the end-of-travel and/or obstacle detection device of the electromechanical actuator 11 is implemented by means of the microcontroller 31 of the control unit 15 and, in particular, by means of an algorithm implemented by this microcontroller 31.

Advantageously, the end-of-travel and/or obstacle detection device of the electromechanical actuator 11 is implemented by measuring a current flowing through the electric motor 16.

Advantageously, the electromechanical actuator 11 further comprises at least one counting device 32a, 32b.

Here, the electromechanical actuator 11 comprises a first counting device 32a and a second counting device 32b. Each of the first and second counting devices 32a, 32b is shown by its outline in FIGS. 2 and 3, without details of its internal components. The first counting device 32a and the first clutch 23a are housed inside a same housing. Similarly, the second counting device 32b and the second clutch 23b are housed inside a same housing.

Each of the first and second counting devices 32a, 32b is configured to cooperate, in other words cooperates, with the control unit 15. Furthermore, each of the first and second counting devices 32a, 32b is configured to, in cooperation with the control unit 15, respectively determine a position, which can be called “current”, of the first drive shaft 9a or of the second drive shaft 9b and, therefore, of the first movable bar 8a or of the second movable bar 8b.

Advantageously, the control unit 15 is configured to monitor at least one signal from each of the first and second counting devices 32a, 32b at a predetermined frequency, especially as a function of the position of the first movable bar 8a or the second movable bar 8b.

Here, each of the first and second counting devices 32a, 32b is of the magnetic type. In such a case, each of the first and second counting devices 32a, 32b can comprise an encoder wheel, not shown, and one or more sensors, not shown, in particular Hall effect sensors. The encoder wheel of each of the first and second counting devices 32a, 32b is connected to the output shaft of the first clutch 23a or the second clutch 23b. Furthermore, the or each sensor is assembled on an electronic board of the control unit 15, in particular on a second electronic board, not shown.

Thus, each of the first and second counting devices 32a, 32b can respectively determine the number of revolutions made by the output shaft of the first clutch 23a or the second clutch 23b.

Here, each of the first and second counting devices 32a, 32b comprises three sensors.

The number of sensors is non-limitative and can be different. It can, for example, be one or two.

In a variant, not shown, each of the first and second counting devices 32a, 32b can be without sensors. In this case, the first and second counting devices 32a, 32b are configured so as to, in cooperation with the control unit 15, analyse the electrical energy supply control signals of the electric motor 16 and to determine respectively a position, which can be called “current”, of the first drive shaft 9a or of the second drive shaft 9b and, therefore, of the first movable bar 8a or of the second movable bar 8b.

In a variant, not shown, each of the first and second counting devices 32a, 32b can respectively determine the number of revolutions made by the output shaft of the first gearbox 19a or the second gearbox 19b.

In another variant, not shown, each of the first and second counting devices 32a, 32b can respectively determine the number of revolutions made by the first coupling element 20a or the second coupling element 20b.

Each of the first and second counting devices 32a, 32b can also respectively determine the direction of rotation of the first coupling element 20a or the second coupling element 20b and/or manage the end-of-travel positions of the first movable bar 8a or the second movable bar 8b.

The type of each of the first and second counting devices is not limitative and can be different. Each of these first and second counting devices can, in particular, be of the optical type, for example an encoder equipped with one or more optical sensors, or of the temporal type.

Here, the first and second counting devices 32a, 32b are identical.

Here, the first counting device 32a is arranged, in other words is configured to be arranged, in particular in the assembled configuration of the electromechanical actuator 11, between the first clutch 23a and the first gearbox 19a. Furthermore, the second counting device 32b is arranged, in other words is configured to be arranged, in particular in the assembled configuration of the electromechanical actuator 11, between the second clutch 23b and the second gearbox 19b.

In a variant, not shown, the first counting device 32a is arranged, in other words is configured to be arranged, in particular in the assembled configuration of the electromechanical actuator 11, inside the first clutch 23a. Furthermore, the second counting device 32b is arranged, in other words is configured to be arranged, in particular in the assembled configuration of the electromechanical actuator 11, inside the second clutch 23b.

In another variant, not shown, the first counting device 32a is arranged, in other words is configured to be arranged, in particular in the assembled configuration of the electromechanical actuator 11, inside the first gearbox 19a. Furthermore, the second counting device 32b is arranged, in other words is configured to be arranged, in particular in the assembled configuration of the electromechanical actuator 11, inside the second gearbox 19b.

The electromechanical actuator 11 comprises at least one torque transmission device 10a, 10b.

Here, the electromechanical actuator 11 comprises a first torque transmission device 10a and a second torque transmission device 10b. The first torque transmission device 10a is connected, on the one hand, to the electric motor 16, in particular by means of the first gearbox 19a and the first clutch 23a, and, on the other hand, to the first drive shaft 9a, in particular by means of the first coupling element 20a. Furthermore, the second torque transmission device 10b is connected, on the one hand, to the electric motor 16, in particular by means of the second gearbox 19b and the second clutch 23b, and, on the other hand, to the second drive shaft 9b, in particular by means of the second coupling element 20b.

Here, the first gearbox 19a, in particular the output shaft of the first gearbox 19a, is coupled, in other words is configured to be coupled, in particular in the assembled configuration of the electromechanical actuator 11, with the first coupling element 20a via the first torque transmission device 10a. Furthermore, the second gearbox 19b, in particular the output shaft of the second gearbox 19b, is coupled, in other words is configured to be coupled, in particular in the assembled configuration of the electromechanical actuator 11, with the second coupling element 20b via the second torque transmission device 10b.

Advantageously, the first and second torque transmission devices 10a, 10b are mounted, in other words are housed, inside the casing 17, in particular in the assembled configuration of the electromechanical actuator 11.

Here, the first and second torque transmission devices 10a, 10b are identical.

In a variant, not shown, the first and second torque transmission devices 10a, 10b are different.

Advantageously, the electromechanical actuator 11 further comprises a coupling device 33, shown in FIGS. 2 and 3.

Advantageously, the coupling device 33 comprises a plurality of gears 37, in particular four in number.

The number of gears in the coupling device is not limitative and can be different, preferably even. It can, for example, be two or six.

Advantageously, the coupling device 33 further comprises an input shaft, which is connected to the first end 21a of the rotor 21, and two output shafts, which are respectively connected to the input shaft 25 of one of the first and second clutches 23a, 23b.

Advantageously, the first end 21a of the rotor 21 of the electric motor 16 is connected directly to the first clutch 23a. Furthermore, the first end 21a of the rotor 21 of the electric motor 16 is connected to the second clutch 23b via the coupling device 33.

Here, the coupling device 33 is mounted, in other words is housed, in particular in the assembled configuration of the electromechanical actuator 11, inside the casing 17.

Here, the coupling device 33 is arranged between the electric motor 16, in particular the first end 21a of the rotor 21 of the electric motor 16, and the first and second clutches 23a, 23b, in particular the input shaft of each of the first and second clutches 23a, 23b.

In a variant, not shown, the coupling device 33 is mounted, in other words is housed, in particular in the assembled configuration of the screening device 3, inside the housing 7, while being arranged outside the casing 17. In this case, the coupling device 33 can be arranged at the second end 7b of the housing 7.

Advantageously, the coupling device 33 has a ratio of one, in other words neither reducing nor amplifying a speed of rotation of the rotor 21 of the electric motor 16.

Advantageously, a first set 22 of a first part of the components 10a, 10b, 15, 16, 19a, 19b, 20a, 20b, 23a, 23b, 29a, 29b, 32a, 32b of the electromechanical actuator 11 are aligned along a first axis of rotation Xa and a second set 26 of a second part of the components 10a, 10b, 15, 16, 19a, 19b, 20a, 20b, 23a, 23b, 29a, 29b, 32a, 32b of the electromechanical actuator 11 are aligned along a second axis of rotation Xb. Furthermore, the first and second axes of rotation Xa, Xb are parallel.

Advantageously, the first assembly 22 comprises the first clutch 23a, the first counting device 32a, the first gearbox 19a, the first brake 29a and the first coupling element 20a. Furthermore, the second assembly 26 comprises the second clutch 23b, the second counting device 32b, the second gearbox 19b, the second brake 29b and the second coupling element 20b.

Here, the electric motor 16 is an integral part of the first assembly 22 and is also aligned along the first axis of rotation Xa.

In a variant, not shown, the electric motor 16 is an integral part of the second assembly 26 and is also aligned along the second axis of rotation Xb.

In a variant, not shown, the coupling device 33 comprises an input shaft, which is connected to the second end 21b of the rotor 21, and an output shaft, which is connected to the input shaft 25 of one of the first and second clutches 23a, 23b. The first end 21a of the rotor 21 of the electric motor 16 is connected directly to the first clutch 23a. Furthermore, the second end 21b of the rotor 21 of the electric motor 16 is connected to the second clutch 23b via the coupling device 33. In this case, the electromechanical actuator 11 can further comprise a connection shaft. Furthermore, in particular in the assembled configuration of the electromechanical actuator 11, the connection shaft is coupled, in other words is configured to be coupled, on the one hand, to the coupling device 33, in particular to the output shaft of the coupling device 33, and, on the other hand, to the second clutch 23b, in particular to the input shaft 25 of the second clutch 23b. Advantageously, the connection shaft is a rigid shaft. Advantageously, the electromechanical actuator 11 further comprises at least a first universal joint and a second universal joint. The coupling device 33 is assembled, in particular in the assembled configuration of the electromechanical actuator 11, with the connection shaft by means of the first universal joint. Furthermore, the second clutch 23b is assembled, in particular in the assembled configuration of the electromechanical actuator 11, with the connection shaft by means of the second universal joint. Thus, the first and second universal joints ensure that torque is transmitted between the coupling device 33 and the second clutch 23b via the connection shaft, while accommodating positional deviations between the output shaft of the coupling device 33 and the input shaft 25 of the second clutch 23b. Advantageously, along the second axis of rotation Xb, at least part of the control unit 15 is arranged between the coupling device 33 and the second clutch 23b, in particular in the assembled configuration of the electromechanical actuator 11. Furthermore, the connection shaft extends, along the second axis of rotation Xb, through a zone of the electromechanical actuator 11 comprising the control unit 15. This zone of the electromechanical actuator 11 is defined, along the second axis of rotation Xb, between the coupling device 33 and the second clutch 23b.

A movement generated by the electric motor 16 is transmitted to the first drive shaft 9a, via the first clutch 23a, the first gearbox 19a and the first coupling element 20a, if the first clutch 23a is in the engaged position. This same movement generated by the electric motor 16 is also transmitted to the second drive shaft 9b, via the coupling device 33, the second clutch 23b, the second gearbox 19a and the second coupling element 20a, if the second clutch 23b is in the engaged position.

Thus, the electromechanical actuator 11 uses this single electric motor 16 and the control unit 15 to drive the screen 2 in a number of ways.

When the first and second clutches 23a, 23b are in the engaged position and the electric motor 16 is electrically activated, the movement generated by the electric motor 16 is transmitted to the first and second drive shafts 9a, 9b, which are then rotated respectively around the first and second axes of rotation Xa, Xb. In this case, the first and second movable bars 8a, 8b perform the same vertical movement simultaneously. This makes it possible to choose the position of an area in which the aperture is concealed.

When only the first clutch 23a is in the engaged position and the electric motor 16 is electrically activated, the movement generated by the electric motor 16 is transmitted only to the first drive shaft 9a. In this case, only the first movable bar 8a moves vertically, while the second movable bar 8b remains in position, in other words is stationary. Thus, it is the height of the concealment area that is modified relative to the aperture.

Similarly, when only the second clutch 23b is in the engaged position and the electric motor 16 is electrically activated, the movement generated by the electric motor 16 is transmitted only to the second drive shaft 9b. In this case, only the second movable bar 8b moves vertically, while the first movable bar 8a remains in position, in other words is stationary. Thus, it is the height of the concealment area that is modified relative to the aperture.

The first and second movable bars 8a, 8b can therefore be moved vertically by the electromechanical actuator 11 separately or simultaneously.

The first torque transmission device 10a and the second torque transmission device 10b belonging to the electromechanical actuator 11 illustrated in FIGS. 1 to 3, are now described, more in detail with reference to FIGS. 4 and 5, according to the first embodiment of the invention.

Each of the first and second torque transmission devices 10a, 10b comprises a drive shaft 38, a first pin 39 and a second pin 40 respectively.

The drive shaft 38 comprises a first end 38a and a second end 38b. The second end 38b is opposite the first end 38a.

The first pin 39 comprises a first end 39a and a second end 39b. The second end 39b is opposite the first end 39a.

The second pin 40 comprises a first end 40a and a second end 40b. The second end 40b is opposite the first end 40a.

Advantageously, the drive shaft 38 is made of a metallic material. Furthermore, the first and second pins 39, 40 are made of a metallic material.

The drive shaft 38 further comprises a first aperture 41 and a second aperture 42. The first aperture 41 is arranged at the first end 38a of the drive shaft 38. The first pin 39 is housed, in other words is mounted, inside the first aperture 41, in particular in an assembled configuration of the first torque transmission device 10a, respectively of the second torque transmission device 10b.

The second aperture 42 is arranged at the second end 38b of the drive shaft 38. The second pin 40 is housed, in other words is mounted, inside the second aperture 42, in particular in the assembled configuration of the first torque transmission device 10a, respectively of the second torque transmission device 10b.

Advantageously, the first pin 39 is fixed, in other words is configured to be fixed, inside the first aperture 41 of the drive shaft 38 and the second pin 40 is fixed inside the second aperture 42 of the drive shaft 38, in particular in the assembled configuration of the first torque transmission device 10a, respectively of the second torque transmission device 10b.

Here, the first pin 39 is crimped, in other words is configured to be crimped, inside the first aperture 41 of the drive shaft 38 and the second pin 40 is crimped, in other words is configured to be crimped, inside the second aperture 42 of the drive shaft 38, in particular in the assembled configuration of the first torque transmission device 10a, respectively of the second torque transmission device 10b.

Advantageously, each of the first and second apertures 41, 42 in the drive shaft 38 is a through-hole of circular cross-section.

Advantageously, the first pin 39 has a first longitudinal axis X 39 and the second pin 40 has a second longitudinal axis X 40. Furthermore, the first longitudinal axis X 39 and the second longitudinal axis X40 are arranged in the same plane P10.

Thus, the first and second pins 39, 40 have the same angular position within the first torque transmission device 10a, respectively the second torque transmission device 10b. In this way, this angular positioning of the first and second pins 39, 40 makes it possible to guarantee homokinetic operation of the first torque transmission device 10a, respectively of the second torque transmission device 10b, in other words the speeds of rotation of the output shaft of the first gearbox 19a, respectively of the output shaft of the second gearbox 19b, and of the first coupling element 20a, respectively of the second coupling element 20b, are the same at each instant, although they are not aligned.

The first gearbox 19a comprises a first housing 43. The first coupling element 20a comprises a second housing 44. The first end 38a of the drive shaft 38 of the first torque transmission device 10a is arranged, in other words is configured to be arranged, in particular in the assembled configuration of the electromechanical actuator 11, inside the first housing 43 of the first gearbox 19a. Furthermore, the second end 38b of the drive shaft 38 of the first torque transmission device 10a is arranged, in other words is configured to be arranged, in particular in the assembled configuration of the electromechanical actuator 11, inside the second housing 44 of the first coupling element 20a. Similarly, the second gearbox 19b comprises a first housing 43. The second coupling element 20b comprises a second housing 44. The first end 38a of the drive shaft 38 of the second torque transmission device 10b is arranged, in other words is configured to be arranged, in particular in the assembled configuration of the electromechanical actuator 11, inside the first housing 43 of the second gearbox 19b. Furthermore, the second end 38b of the drive shaft 38 of the second torque transmission device 10b is arranged, in other words is configured to be arranged, in particular in the assembled configuration of the electromechanical actuator 11, inside the second housing 44 of the second coupling element 20b.

X10a and X10b are axes of rotation, which can also be referred to as second axes of rotation, of the first torque transmission device 10a and the second torque transmission device 10b respectively. Each axis of rotation X10a, X10b is the axis of rotation of the first housing 43 of the first or second gearbox 19a, 19b.

X20a and X20b are axes of rotation, which can also be referred to as the first axes of rotation, of the first coupling element 20a and the second coupling element 20b respectively. Each axis of rotation X20a, X20b is the axis of rotation of the second housing 44 of the first or second coupling element 20a, 20b.

Here, the first and second axes of rotation Xa, Xb of the first and second drive shafts 9a, 9b are coincident with the axes of rotation X20a, X20b of the first and second coupling elements 20a, 20b.

Thus, this design of the electromechanical actuator 11 makes it possible to transmit, in other words is configured to transmit, from the electric motor 16, a torque, in particular a large amount, to the first coupling element 20a, via the first torque transmission device 10a, when the axis of rotation X10a of the first torque transmission device 10a and the axis of rotation X20a of the first coupling element 20a are out of alignment. This design of the electromechanical actuator 11 also makes it possible to transmit, in other words is configured to transmit, from the electric motor 16, a torque, in particular a large amount, to the second coupling element 20b, via the second torque transmission device 10b, when the axis of rotation X10b of the second torque transmission device 10b and the axis of rotation X20b of the second coupling element 20b are out of alignment.

Here and as illustrated in FIG. 3, a first value of misalignment D1 between the axis of rotation X10a of the first torque transmission device 10a and the axis of rotation X20a of the first coupling element 20a is different from a second value of misalignment D 2 between the axis of rotation X10b of the second torque transmission device 10b and the axis of rotation X20b of the second coupling element 20b. Advantageously, these misalignment values D1, D2 are measured in the plane P.

Thus, the difference between, on the one hand, the first value of misalignment D1 of the axis of rotation X10a of the first torque transmission device 10a with respect to the axis of rotation X20a of the first coupling element 20a and, on the other hand, the second value of misalignment D2 of the axis of rotation X10b of the second torque transmission device 10b with respect to the axis of rotation X20b of the second coupling element 20b allows the electromechanical actuator 11 to be adapted to different dimensions of the housing 7, in particular the width L thereof.

Indeed, the distance between the first and second axes Xa, Xb, on which the axes X20a, X20b of the first and second coupling elements 20a, 20b are aligned respectively, can vary as a function of the dimensions of the housing 7, especially the width L thereof, whereas the distance between the axes X10a, X10b of the first and second torque transmission devices 10a, 10b remains constant, in whatever the housing 7 the electromechanical actuator 11 is installed.

In a variant, not shown, in the assembled configuration of the screening device 3, the first value of misalignment D1 between the axis of rotation X10a of the first torque transmission device 10a and the axis of rotation X20a of the first coupling element 20a is equal to the second value of misalignment D2 between the axis of rotation X10b of the second torque transmission device 10b and the axis of rotation X20b of the second coupling element 20b.

Advantageously, each of the first and second ends 38a, 38b of the drive shaft 38 of the first torque transmission device 10a, respectively of the second torque transmission device 10b, is spherical in shape, in particular convex. Furthermore, the first housing 43 of the first gearbox 19a, respectively of the second gearbox 19b, and the second housing 44 of the first coupling element 20a, respectively of the second coupling element 20b, have a shape of revolution, respectively around the axes of rotation X10a, X10b, X20a, X20b, in particular concave.

Here, the first gearbox 19a further comprises a first interface element 45a. Furthermore, the second gearbox 19b further comprises a second interface element 45b. Advantageously, the first housing 43 of the first gearbox 19a is arranged inside the first interface element 45a. Furthermore, the first housing 43 of the second gearbox 19b is arranged inside the second interface element 45b.

Advantageously, the first torque transmission device 10a, respectively the second torque transmission device 10b, further comprises a first transmission element 50 and a second transmission element 51.

Advantageously, the first transmission element 50 of the first torque transmission device 10a, respectively of the second torque transmission device 10b, is fixed, in other words is configured to be fixed, in particular in the assembled configuration of the electromechanical actuator 11, on the first pin 39 of the first torque transmission device 10a, respectively of the second torque transmission device 10b. Furthermore, the second transmission element 51 of the first torque transmission device 10a, respectively of the second torque transmission device 10b, is fixed, in other words is configured to be fixed, in particular in the assembled configuration of the electromechanical actuator 11, on the second pin 40 of the first torque transmission device 10a, respectively of the second torque transmission device 10b.

Advantageously, the first gearbox 19a, in particular the first interface element 45a, respectively the second gearbox 19b, in particular the second interface element 45b, comprises a first groove 46. The first groove 46 emerges inside the first housing 43 of the first gearbox 19a, respectively of the second gearbox 19b.

Advantageously, the first coupling element 20a, respectively the second coupling element 20b, comprises a second groove 47. The second groove 47 emerges inside the second housing 44 of the first coupling element 20a, respectively of the second coupling element 20b.

Advantageously, the first transmission element 50 of the first torque transmission device 10a, respectively of the second torque transmission device 10b, is housed, in other words is mounted, in particular in the assembled configuration of the electromechanical actuator 11, inside the first groove 46 of the first gearbox 19a, respectively of the second gearbox 19b. Furthermore, the second transmission element 51 of the first torque transmission device 10a, respectively of the second torque transmission device 10b, is housed, in other words is mounted, in particular in the assembled configuration of the electromechanical actuator 11, inside the second groove 47 of the first coupling element 20a, respectively of the second coupling element 20b.

Thus, the arrangement of the first transmission element 50 of the first torque transmission device 10a inside the first groove 46 of the first gearbox 19a maximises a bearing surface between the first pin 39 of the first torque transmission device 10a and the first gearbox 19a, in particular the first interface element 45a. Furthermore, the arrangement of the second transmission element 51 of the first torque transmission device 10a inside the second groove 47 of the first coupling element 20a maximises a bearing surface between the second pin 40 of the first torque transmission device 10a and the first coupling element 20a. Similarly, the arrangement of the first transmission element 50 of the second torque transmission device 10b inside the first groove 46 of the second gearbox 19b maximises a bearing surface between the first pin 39 of the second torque transmission device 10b and the second gearbox 19b, in particular the second interface element 45b. Furthermore, the arrangement of the second transmission element 51 of the second torque transmission device 10b inside the second groove 47 of the second coupling element 20b maximises a bearing surface between the second pin 40 of the second torque transmission device 10b and the second coupling element 20b.

In this way, the arrangement of the first transmission element 50 of the first torque transmission device 10a inside the first groove 46 of the first gearbox 19a makes it possible to reduce stresses on the first pin 39 of the first torque transmission device 10a and on the first gearbox 19a, in particular on the first interface element 45a. Furthermore, the arrangement of the second transmission element 51 of the first torque transmission device 10a inside the second groove 47 of the first coupling element 20a makes it possible to reduce stresses on the second pin 40 of the first torque transmission device 10a and on the first coupling element 20a. Similarly, the arrangement of the first transmission element 50 of the second torque transmission device 10b inside the first groove 46 of the second gearbox 19b reduces stresses on the first pin 39 of the second torque transmission device 10b and on the second gearbox 19b, in particular on the second interface element 45b. Furthermore, the arrangement of the second transmission element 51 of the second torque transmission device 10b inside the second groove 47 of the second coupling element 20b makes it possible to reduce stresses on the second pin 40 of the second torque transmission device 10b and on the second coupling element 20b.

In the second embodiment, shown in FIGS. 6 and 7, the elements similar to those of the first embodiment have the same references and operate as explained above. In the following, only the main differences between this second embodiment and the previous one are described. In the following, where a reference sign is used without being reproduced in FIGS. 6 and 7 or is reproduced in FIGS. 6 and 7 without being mentioned in the description, it corresponds to the object bearing the same reference in one of FIGS. 1 to 5.

With reference to FIGS. 6 and 7, the electromechanical actuator 11 according to the second embodiment of the invention and, more particularly, the first torque transmission device 10a and the second torque transmission device 10b are now described.

Here, the first torque transmission device 10a, respectively the second torque transmission device 10b, is devoid of a first transmission element 50 and a second transmission element 51.

Here, each of the first and second ends 38a, 38b of the drive shaft 38 of the first torque transmission device 10a, respectively of the second torque transmission device 10b, is spherical in shape. Furthermore, the first housing 43 of the first gearbox 19a, respectively of the second gearbox 19b, and the second housing 44 of the first coupling element 20a, respectively of the second coupling element 20b, have a shape of revolution, respectively around the axes of rotation X10a, X10b, X20a, X20b, in particular are cylindrical in shape. Thus, the spherical shape of the first end 38a and of the second end 38b of the drive shaft 38 of the first torque transmission device 10a make it possible to hold in position, in other words are configured to hold in position, these first and second ends 38a, 38b respectively inside the first housing 43 of the first gearbox 19a and the second housing 44 of the first coupling element 20a, which are cylindrical in shape, while ensuring a ball-and-socket connection of the first end 38a and the second end 38b of the drive shaft 38 respectively inside the first housing 43 of the first gearbox 19a and the second housing 44 of the first coupling element 20a.

Furthermore, the spherical shape of the first end 38a and of the second end 38b of the drive shaft 38 of the second torque transmission device 10b make it possible to hold in position, in other words are configured to hold in position, these first and second ends 38a, 38b respectively inside the first housing 43 of the second gearbox 19b and the second housing 44 of the second coupling element 20b, which are cylindrical in shape, while guaranteeing a ball-and-socket connection of the first end 38a and the second end 38b of the drive shaft 38 respectively inside the first housing 43 of the second gearbox 19b and the second housing 44 of the second coupling element 20b.

Here, the first gearbox 19a, respectively the second gearbox 19b, comprises two first grooves 46. Each of the first grooves 46 emerges inside the first housing 43 of the first gearbox 19a, respectively of the second gearbox 19b.

Advantageously, the first grooves 46 of the first gearbox 19a, respectively of the second gearbox 19b, are arranged inside the first interface element 45a, respectively of the second interface element 45b.

Here, the first coupling element 20a, respectively the second coupling element 20b, comprises two second grooves 47. Each of the second grooves 47 emerges inside the interior of the second housing 44 of the first coupling element 20a, respectively of the second coupling element 20b.

Here, each of the first and second ends 39a, 39b of the first pin 39 of the first torque transmission device 10a, respectively of the second torque transmission device 10b, is housed inside one of the first grooves 46 of the first gearbox 19a, respectively of the second gearbox 19b. Furthermore, each of the first and second ends 40a, 40b of the second pin 40 of the first torque transmission device 10a, respectively of the second torque transmission device 10b, is housed inside one of the second grooves 47 of the first coupling element 20a, respectively of the second coupling element 20b.

Thus, the first and second ends 39a, 39b of the first pin 39 of the first torque transmission device 10a and the first and second ends 40a, 40b of the second pin 40 of the first torque transmission device 10a slide, in other words are configured to slide, respectively inside the first grooves 46 of the first gearbox 19a and the second grooves 47 of the first coupling element 20a.

Furthermore, the first and second ends 39a, 39b of the first pin 39 of the second torque transmission device 10b and the first and second ends 40a, 40b of the second pin 40 of the second torque transmission device 10b slide, in other words are configured to slide, respectively inside the first grooves 46 of the second gearbox 19b and the second grooves 47 of the second coupling element 20b.

In the third embodiment, shown in FIGS. 8 and 9, the elements similar to those of the first and second embodiments have the same references and operate as explained above. In the following, only the main differences between this third embodiment and the previous ones are described. In the following, where a reference sign is used without being reproduced in FIGS. 8 and 9 or is reproduced in FIGS. 8 and 9 without being mentioned in the description, it corresponds to the object bearing the same reference in one of FIGS. 1 to 7.

With reference to FIGS. 8 and 9, the electromechanical actuator 11 according to the third embodiment of the invention and, more particularly, the first torque transmission device 10a and the second torque transmission device 10b are now described.

Here, the first torque transmission device 10a, respectively the second torque transmission device 10b, is devoid of a first transmission element 50 and a second transmission element 51.

Here, the first gearbox 19a, in particular the first interface element 45a, respectively the second gearbox 19b, in particular the second interface element 45b, comprises two first orifices 48. Each of the first orifices 48 of the first gearbox 19a, respectively of the second gearbox 19b, emerges inside the first housing 43 of the first gearbox 19a, respectively of the second gearbox 19b.

Here, the first coupling element 20a, respectively the second coupling element 20b, comprises two second orifices 49. Each of the second orifices 49 of the first coupling element 20a, respectively of the second coupling element 20b, emerges inside the second housing 44 of the first coupling element 20a, respectively of the second coupling element 20b.

Here, each of the first and second ends 39a, 39b of the first pin 39 of the first torque transmission device 10a, respectively of the second torque transmission device 10b, is fixed, in other words is configured to be fixed, in particular in the assembled configuration of the electromechanical actuator 11, inside one of the first orifices 48 of the first gearbox 19a, respectively of the second gearbox 19b. Furthermore, each of the first and second ends 40a, 40b of the second pin 40 of the first torque transmission device 10a, respectively of the second torque transmission device 10b, is fixed, in other words is configured to be fixed, in particular in the assembled configuration of the electromechanical actuator 11, inside one of the second orifices 49 of the first coupling element 20a, respectively of the second coupling element 20b.

In particular, each of the first and second ends 39a, 39b of the first pin 39 of the first torque transmission device 10a, respectively of the second torque transmission device 10b, is crimped, in particular in the assembled configuration of the electromechanical actuator 11, in other words is configured to be crimped, inside one of the first orifices 48 of the first gearbox 19a, respectively of the second gearbox 19b. Furthermore, each of the first and second ends 40a, 40b of the second pin 40 of the first torque transmission device 10a, respectively of the second torque transmission device 10b, is crimped, in other words is configured so be crimped, in particular in the assembled configuration of the electromechanical actuator 11, inside one of the second orifices 49 of the first coupling element 20a, respectively of the second coupling element 20b.

Advantageously, each of the first and second apertures 41, 42 of the drive shaft 38 of the first torque transmission device 10a, respectively of the second torque transmission device 10b, is in the form of a groove.

Here, the groove is formed by two trapezoidal-section indentations joined together, at their narrowest points.

Thus, each of the first and second apertures 41, 42 of the drive shaft 38 of the first torque transmission device 10a, respectively of the second torque transmission device 10b, makes it possible to produce a ball-and-socket connection at each of the first and second ends 38a, 38b of the drive shaft 38 of the first torque transmission device 10a, respectively of the second torque transmission device 10b, with one of the first and second pins 39, 40 of the first torque transmission device 10a, respectively of the second torque transmission device 10b.

Thanks to the present invention, whatever the embodiment, the design of the electromechanical actuator makes it possible to transmit, from the electric motor, a torque, in particular a large amount, to the coupling element, via the torque transmission device, when the second axis of rotation of the torque transmission device and the first axis of rotation of the coupling element are out of alignment, in particular by a large amount.

Numerous modifications can be made to the above-described embodiments, without departing from the scope of the invention defined by the claims.

In a variant, not shown, the screening device 3 comprises only one movable bar, namely either the first movable bar 8a or the second movable bar 8b.

In a variant, not shown, the screening device 3 comprises a number of movable bars greater than or equal to three, all of which can be moved by means of the electromechanical actuator 11, respectively via a gearbox, a torque transmission device and, eventually, a clutch, a counting device and a brake.

In a variant, not shown, the first and second cords 4a, 4b, as well as the third and fourth cords 4c, 4d, in particular their ends, are fastened to a structure of a window or door or to a wall of a building, in particular by means of retaining elements. Thus, the screening device 3 can not have a housing, in other words a rail, located at the top or above the aperture. In this case, the retaining elements are configured to be fastened, in other words are fastened, to the structure of the window or door or to the wall of the building by means of fastening screws, not shown. The fastening screws pass through through-holes in the retaining elements and are screwed either into plugs, not shown, housed in the structure of the window or door or in the wall of the building, or directly into the structure of the window or door or in the wall of the building. Moreover, the length of the first, second, third and fourth cords 4a, 4b, 4c, 4d is designed so that they are permanently taut in relation to the structure of the window or door or the wall of the building, so as to allow the first and second movable bars 8a, 8b to move along them. In this case, the motorized driving device 5, in particular the electromechanical actuator 11, is mounted, in other words is housed, inside one of the movable bars 8a, 8b, in particular in the assembled configuration of the screening device 3.

In another variant, not shown, the first, second, third and fourth cords 4a, 4b, 4c, 4d can be kept taut by means of one or more resilient return elements, such as, for example, one or more springs.

In a variant, the electric motor 16 of the electromechanical actuator 11 can be of the asynchronous type.

In a variant, not shown, the electromechanical actuator 11 further comprises at least one other electric motor. Thus, the electromechanical actuator 11 comprises the electric motor 16, which can be referred to as the first electric motor, and a second electric motor, which are in particular identical. In this case, the electromechanical actuator 11 has no coupling device 33 and no first and second clutches 23a, 23b. Thus, the first electric motor 16 is configured to rotate, in other words rotates, the first coupling element 20a, via the first gearbox 19a and the first torque transmission device 10a, and the second electric motor is configured to rotate, in other words rotates, the second coupling element 20b, via the second gearbox 19b and the second torque transmission device 10b. In this case, the first assembly 22 comprises the first electric motor 16, which is aligned along the first axis of rotation Xa, and the second assembly 26 comprises the second electric motor, which is aligned along the second axis of rotation Xb.

Whatever the embodiment, one or each of the first, second, third and fourth cords 4a, 4b, 4c and 4d can be replaced by a chain.

Furthermore, the contemplated embodiments and variants can be combined to form new embodiments of the invention, without departing from the scope of the invention defined by the claims.

1. An electromechanical actuator for a screening device,
the electromechanical actuator comprising at least
a casing,
an electric motor,
a gearbox,
a coupling element the coupling element comprising a first axis of rotation, and
a torque transmission device the torque transmission device comprising a second axis of rotation,
the electric motor, the gearbox and the torque transmission device being housed inside the casing,
the gearbox being coupled to the coupling element via the torque transmission device
wherein
the torque transmission device comprises at least:
a drive shaft
a first pin, and
a second pin,
the drive shaft comprises at least:
a first end and a second end, the second end being opposite the first end,
a first aperture the first aperture being arranged at the first end the first pin being housed within the first aperture and
a second aperture, the second aperture being arranged at the second end the second pin being housed inside the second aperture,
the gearbox comprises at least one first housing, the first end of the drive shaft being arranged inside the first housing of the gearbox,
in that the coupling element comprises at least one second housing, the second end of the drive shaft being arranged inside the second housing of the coupling element,
and the electromechanical actuator is configured to transmit torque, from the electric motor, to the coupling element, via the torque transmission device, when the second axis of rotation of the torque transmission device and the first axis of rotation of the coupling element are out of alignment.

2. The electromechanical actuator for a screening device according to claim 1, wherein
each of the first and second ends of the drive shaft is spherical in shape,
and the first housing of the gearbox and the second housing of the coupling element have a shape of revolution, respectively around an axis of rotation.

3. The electromechanical actuator for a screening device according to claim 1, wherein
the gearbox further comprises at least one interface element and in that the first housing of the gearbox is arranged inside the interface element.

4. The electromechanical actuator for a screening device according to claim 1, wherein
in that the torque transmission device further comprises:
a first transmission element and
a second transmission element,
the first transmission element is fixed to the first pin,
the second transmission element is fixed to the second pin,
the gearbox comprises a first groove the first groove emerging inside the first housing of the gearbox,
the coupling element comprises a second groove, the second groove emerging inside the second housing of the coupling element
the first transmission element is housed inside the first groove of the gearbox,
and the second transmission element is housed inside the second groove of the coupling element.

5. The electromechanical actuator for a screening device according to claim 1, wherein
the gearbox comprises two first grooves, each of the first grooves emerging inside the first housing of the gearbox,
the coupling element comprises two second grooves, each of the second grooves emerging inside the second housing of the coupling element
the first pin comprises a first end and a second end the second end being opposite the first end,
the second pin comprises a first end and a second end, the second end being opposite the first end,
each of the first and second ends of the first pin is housed inside one of the first grooves of the gearbox,
and each of the first and second ends of the second pin is housed inside one of the second grooves of the coupling element.

6. The electromechanical actuator for a screening device according to claim 1, wherein
the gearbox comprises two first orifices, each of the first orifices emerging inside the first housing of the gearbox,
the coupling element comprises two second orifices, each of the second orifices emerging inside the second housing of the coupling element,
the first pin comprises a first end and a second end, the second end being opposite the first end,
the second pin comprises a first end and a second end the second end being opposite the first end
each of the first and second ends of the first pin is fixed inside one of the first orifices of the gearbox,
and each of the first and second ends of the second pin is fixed inside one of the second orifices of the coupling element.

7. A screening device
the screening device comprising at least:
a screen, the screen comprising a first end and a second end, the second end being opposite the first end,
a first movable bar, the first end of the screen being connected to the first movable bar, and
a motorized driving device the motorized driving device being configured to move the screen,
the motorized driving device comprising at least
an electromechanical actuator according to claim 1,, the electromechanical actuator being configured to move the first movable bar.

8. The screening device according to claim 7, wherein the screening device further comprises:
a first cord or a first chain,
a second cord or a second chain,
a first drive arrangement the first drive arrangement being configured to cooperate with the first cord or the first chain, and
a second drive arrangement, the second drive arrangement being configured to cooperate with the second cord or the second chain,
and the electromechanical actuator is configured to move the first movable bar by means of the first and second cords or chains,

9. The screening device according to claim 7, wherein
in that the screening device further comprises:
a second movable bar, the second end of the screen being connected to
the second movable bar,
and in that the electromechanical actuator is configured to move the second movable bar.

10. The screening device according to claim 9, wherein the screening device further comprises:
a third cord or a third chain,
a fourth cord or a fourth chain,
a third drive arrangement, the third drive arrangement being configured to cooperate with the third cord or the third chain, and
a fourth drive arrangement the fourth drive arrangement being configured to cooperate with the fourth cord or the fourth chain,
and the electromechanical actuator is configured to move the second movable bar by means of the third and fourth cords or chains,

11. The electromechanical actuator for a screening device according to claim 2, wherein
the gearbox further comprises at least one interface element,
and the first housing of the gearbox is arranged inside the interface element.

12. The electromechanical actuator for a screening device according to claim 2, wherein
the torque transmission device further comprises
a first transmission element, and
a second transmission element,
the first transmission element is fixed to the first pin,
the second transmission element is fixed to the second pin,
the gearbox comprises a first groove, the first groove emerging inside the first housing of the gearbox,
the coupling element comprises a second groove, the second groove emerging inside the second housing of the coupling element,
the first transmission element is housed inside the first groove of the gearbox,
and the second transmission element is housed inside the second groove of the coupling element.

13. The electromechanical actuator for a screening device according to claim 3, wherein
the torque transmission device further comprises
a first transmission element, and
a second transmission element,
the first transmission element is fixed to the first pin,
the second transmission element is fixed to the second pin,
the gearbox comprises a first groove, the first groove emerging inside the first housing of the gearbox,
the coupling element comprises a second groove, the second groove emerging inside the second housing of the coupling element,
the first transmission element is housed inside the first groove of the gearbox, and the second transmission element is housed inside the second groove of the coupling element.

14. The electromechanical actuator for a screening device according to claim 2, wherein
the gearbox comprises two first grooves, each of the first grooves emerging inside the first housing of the gearbox,
the coupling element comprises two second grooves, each of the second grooves emerging inside the second housing of the coupling element,
the first pin comprises a first end and a second end, the second end being opposite the first end,
the second pin comprises a first end and a second end, the second end being opposite the first end,
each of the first and second ends of the first pin is housed inside one of the first grooves of the gearbox,
and each of the first and second ends of the second pin is housed inside one of the second grooves of the coupling element.

15. The electromechanical actuator for a screening device according to claim 3, wherein
the gearbox comprises two first grooves, each of the first grooves emerging inside the first housing of the gearbox,
the coupling element comprises two second grooves, each of the second grooves emerging inside the second housing of the coupling element,
the first pin comprises a first end and a second end, the second end being opposite the first end,
the second pin comprises a first end and a second end, the second end being opposite the first end,
each of the first and second ends of the first pin is housed inside one of the first grooves of the gearbox,
and each of the first and second ends of the second pin is housed inside one of the second grooves of the coupling element.

16. The electromechanical actuator for a screening device according to claim 2, wherein
the gearbox comprises two first orifices, each of the first orifices emerging inside the first housing of the gearbox,
the coupling element comprises two second orifices, each of the second orifices emerging inside the second housing of the coupling element,
the first pin comprises a first end and a second end, the second end being opposite the first end,
the second pin comprises a first end and a second end, the second end being opposite the first end,
each of the first and second ends of the first pin is fixed inside one of the first orifices of the gearbox,
and each of the first and second ends of the second pin is fixed inside one of the second orifices of the coupling element.

17. The electromechanical actuator for a screening device according to claim 3, wherein
the gearbox comprises two first orifices, each of the first orifices emerging inside the first housing of the gearbox,
the coupling element comprises two second orifices, each of the second orifices emerging inside the second housing of the coupling element,
the first pin comprises a first end and a second end, the second end being opposite the first end,
the second pin comprises a first end and a second end, the second end being opposite the first end,
each of the first and second ends of the first pin is fixed inside one of the first orifices of the gearbox,
and each of the first and second ends of the second pin is fixed inside one of the second orifices of the coupling element.

18. A screening device,
the screening device comprising at least
a screen, the screen comprising a first end and a second end, the second end being opposite the first end,
a first movable bar, the first end of the screen being connected to the first movable bar, and
a motorized driving device, the motorized driving device being configured to move the screen,
the motorized driving device comprising at least
an electromechanical actuator according to claim 2, the electromechanical actuator being configured to move the first movable bar.

19. A screening device,
the screening device comprising at least
a screen, the screen comprising a first end and a second end, the second end being opposite the first end,
a first movable bar, the first end of the screen being connected to the first movable bar, and
a motorized driving device, the motorized driving device being configured to move the screen,
the motorized driving device comprising at least
an electromechanical actuator according to claim 3, the electromechanical actuator being configured to move the first movable bar.

20. The screening device according to claim 8, wherein
the screening device further comprises
a second movable bar, the second end of the screen being connected to the second movable bar,
and the electromechanical actuator is configured to move the second movable bar.
